(19) United States
(12) Patent Application Publication
(10) Pub. No.: US 2007/0245236 A1
(43) Pub. Date: Oct. 18, 2007

(54) Method and apparatus to generate XHTML data in device

(75) Inventor: Jun-seung Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/708,043

(22) Filed: Feb. 20, 2007

Related U.S. Application Data
(60) Provisional application No. 60/791,409, filed on Apr. 13, 2006.

(30) Foreign Application Priority Data
May 12, 2006 (KR) 2006-43136

(51) Int. Cl. G06F 15/00

(52) U.S. Cl. 715/530

(57) ABSTRACT

A method and apparatus to generate extensible hypertext markup language (XHTML) data of a device such that a user can generate print data by editing a layout of digital content in a device.

### CROSS-REFERENCE TO RELATED APPLICATIONS

This application claims the benefit of U.S. Provisional Application No. 60/791,409 filed on Apr. 13, 2006, in the United States Patent and Trademark Office and Korean Patent Application No. 2006-43136, filed on May 12, 2006, in the Korean Intellectual Property Office, the disclosures of which are incorporated herein by reference.

### BACKGROUND OF THE INVENTION

1. Field of the Invention

Aspects of the present invention relate to a device, and more particularly, to a method and apparatus to edit a layout of digital content and to generate extensible hypertext markup language (XHTML)-Print data in a device.

2. Description of the Related Art

When a user wants to print digital content by using a device, the user first selects a layout desired to be printed from among layouts already stored in the device. Then, the device applies the layout selected by the user to generate extensible hypertext markup language (XHTML)-Print data. However, in general, when the user selects a layout, the user can edit the layout by only using a template already stored in the device. Accordingly, since the user may only use the already-stored template when editing the layout, it is difficult for the user to obtain a desired print result.

### SUMMARY OF THE INVENTION

Aspects of the present invention provide a method and apparatus to allow a user to edit a layout of digital content and generate extensible hypertext markup language (XHTML)-Print data in a device.

According to an aspect of the present invention, there is provided a method of generating extensible hypertext markup language (XHTML)-Print data in a device in which XHTML-Print data is generated, the method including: selecting one or more digital content files; editing a layout in relation to the selected one or more digital content files; and generating XHTML data by applying the edited layout.

According to an aspect of the present invention, the editing of the layout may include: providing an interface for a user to edit the layout in relation to the selected one or more digital content files; and receiving an input to edit the layout in relation to the selected one or more digital content files through the provided interface.

According to an aspect of the present invention, in the interface, the layout to be edited and a list of the selected one or more digital content files may be separately displayed.

According to an aspect of the present invention, in the interface, if the digital content is image content, the layout may be edited by setting at least one of a position of the image in the layout, a size of the image, and a rotation angel of the image.

According to an aspect of the present invention, in the interface, if the digital image is text content, the layout may be edited by setting at least one of a contents of the text, a position of the text in the layout, a size of the space of the text, and a properties of the text.

According to an aspect of the present invention, in the interface, the user may select a digital content file from the list of the one or more selected digital content files so that the layout is formed.

According to an aspect of the present invention, in the interface, the size and position of the digital content forming the layout may be displayed by using lines or areas.

According to an aspect of the present invention, in the interface, digital content files may be displayed in a part where the list of the selected one or more digital content files is displayed, and identifiers corresponding to the displayed digital content files may be displayed in a part in which the layout is edited.

According to an aspect of the present invention, in the interface, if the user selects a predetermined digital content file from the list of the selected one or more digital content files, the digital content file in the layout corresponding to the selected digital content file may be distinctively displayed.

According to an aspect of the present invention, the interface may allow the user to add a plurality of identical digital content files in the layout.

According to an aspect of the present invention, the interface may allow to the user to edit or delete each digital content file forming the layout.

According to an aspect of the present invention, the method may further include providing a preview of the edited layout to the user.

According to an aspect of the present invention, in the generating of the XHTML-Print data, the edited layout information may be stored, and the stored layout information may be generated as the XHTML-Print data.

According to an aspect of the present invention, the method may further include printing the generated XHTML data.

According to another aspect of the present invention, there is provided a computer readable recording medium having embodied thereon a computer program to execute the method.

According to another aspect of the present invention, there is provided an apparatus to generate XHTML-Print data in a device in which XHTML-Print data is generated, the apparatus including: a data selection unit to select one or more digital content files; a layout editing unit to edit a layout of the selected one or more digital content files; and a data generation unit to generate XHTML data by applying the edited layout.

According to an aspect of the present invention, the layout editing unit may include: an interface providing unit to provide an interface for a user to edit a layout of the selected one or more digital content files; and an editing input unit to receive an input to edit the layout of the selected one or more digital content files through the provided interface.

According to an aspect of the present invention, digital content files may be displayed in a part where a list of the selected one or more digital content files is displayed, and identifiers corresponding to the displayed digital content files may be displayed in a part in which the layout is edited.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a flowchart of a method of generating extensible hypertext markup language (XHTML)-Print data in a device according to an embodiment of the present invention;

FIG. 1B is a detailed flowchart of a layout editing operation of the method of generating XHTML-Print data in a device according to an embodiment of the present invention;

FIG. 2 is a block diagram of an apparatus to generate XHTML-Print data in a device according to an embodiment of the present invention;

FIG. 3 illustrates an interface provided by a mobile device in order to receive an input of a user to select content displayed in an operation of the method of generating XHTML-Print data of a device according to an embodiment of the present invention;

FIG. 4 illustrates an interface provided by a mobile device in order for a user to set a layout in an operation of the method of generating XHTML-Print data of a device according to an embodiment of the present invention;

FIG. 5 illustrates a content selection menu and a manipulation menu of a method and apparatus to generate XHTML-Print data of a device according to an embodiment of the present invention;

FIG. 6 illustrates an interface provided in an operation of the method of generating XHTML-Print data of a device according to an embodiment of the present invention;

FIGS. 7 through 9 illustrate layout editing interfaces in which a plurality of digital content files is inserted into layouts according to an embodiment of the present invention;

FIG. 10 illustrates an interface to edit a layout of text content according to an embodiment of the present invention;

FIG. 11 illustrates an interface to edit a layout of image content according to an embodiment of the present invention;

FIG. 12A illustrates a data structure storing editing information of a layout generated by receiving an input of a user to set a layout when digital content is image content, according to an embodiment of the present invention;

FIG. 12B illustrates a data structure storing editing information of a layout generated by receiving an input of a user to set a layout when digital content is text content, according to an embodiment of the present invention;

FIG. 13 illustrates a preview interface provided by a method and apparatus to generate XHTML-Print data of a device according to an embodiment of the present invention; and

FIG. 14 illustrates the data structures shown in FIGS. 12A and 12B in XHTML-Print data according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

While described in terms of an extensible hypertext markup language (XHTML)-Print document to be explained hereinafter, it is understood that aspects of the invention can be applied to an XHTML document or to a markup having another format.

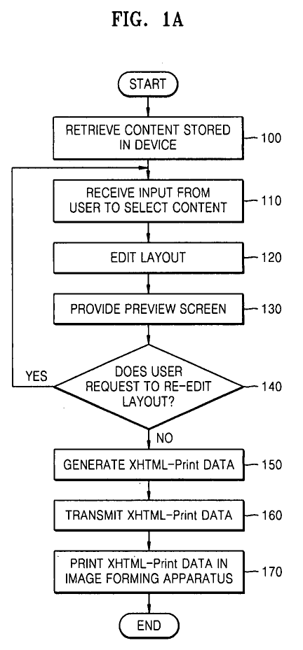

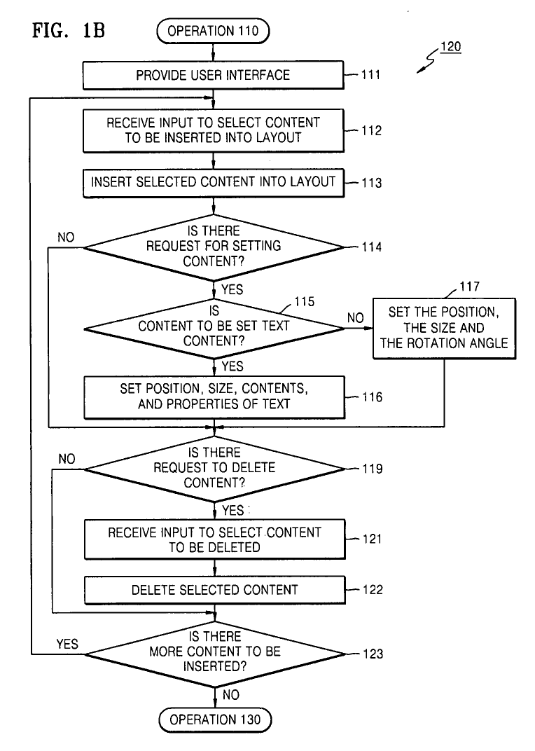

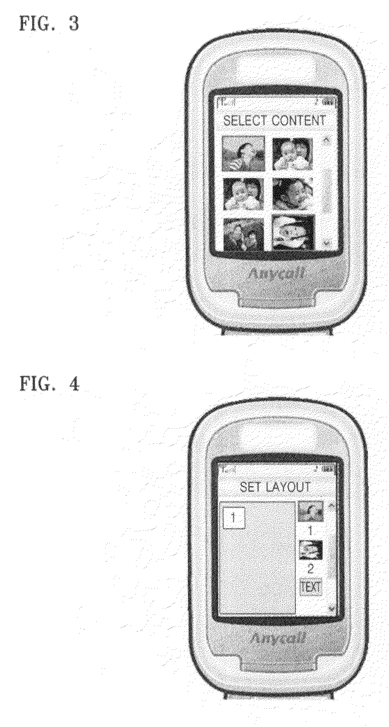

FIGS. 1A and 1B are flowcharts of a method of generating XHTML-Print data in a device according to an embodiment of the present invention. An example of the method will be shown in FIGS. 3-11 using examples from a mobile phone, which is a type of device on which the invention can be implemented. First, digital content, such as image content or text content, stored in a device is retrieved in operation 100. It is understood that the digital content may also be stored in an external device and/or storage medium, and the device may retrieve this digital content through a transmittal in a wired or wireless communication method. Furthermore, the device may display a preview or thumbnail image or description of this digital content, wherein only the digital content selected by a user may be retrieved through the transmittal. While shown in the context of a camera phone, it is understood that the device need not be a phone, need not have an integrated camera, and need not be portable in all aspects of the invention.

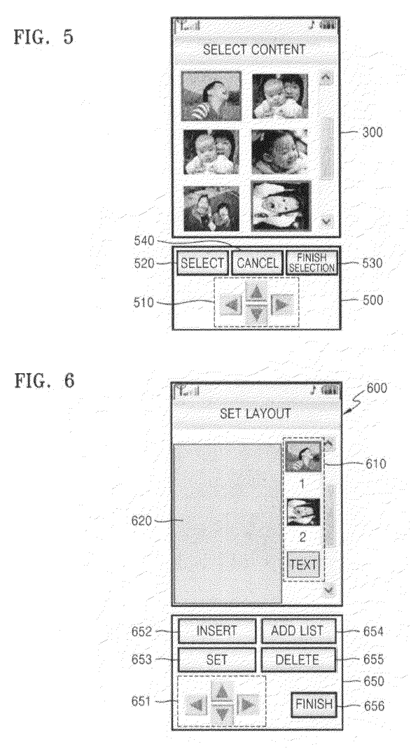

An input from the user to select digital content to be used to make a layout from among the digital content files retrieved in operation 100 is received in operation 110. FIG. 3 illustrates a device providing an interface to receive an input of a user to select content in operation 110. FIG. 5 illustrates a content selection menu 300 and a manipulation menu 500. In operation 110, digital content files retrieved in operation 100 are displayed on the content selection menu 300.

The manipulation menu 500 allows the user to select content files to be used to make a layout from among the displayed content files. By using a direction button 510 disposed on the manipulation menu 500, the user indicates a selection of digital content. If a signal of a selection button 520 is input by the user, a predetermined content file corresponding to the manipulation of the direction button 510 is selected. It is understood that, according to other aspects of the present invention, the device may include other methods to select digital content files displayed on the device, such as a touch screen, a drag-and-drop functionality, and/or a plurality of buttons. The digital content selected by the user is inscribed by thick solid lines of a predetermined color. However, it is understood that the selection may be indicated by other distinctive means, such as blurring a thumbnail image of the selected digital content. A cancel button 540 is provided to cancel a selection of digital content by the user. In operation 110, a plurality of digital content files can be selected, and when a selection finish button 530 is selected by the user, operation 120 is performed.

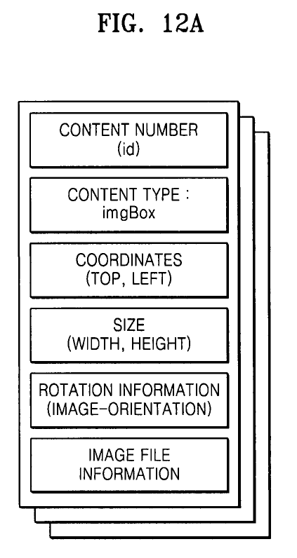

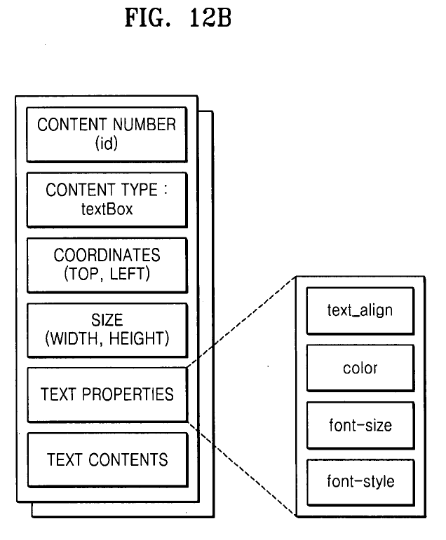

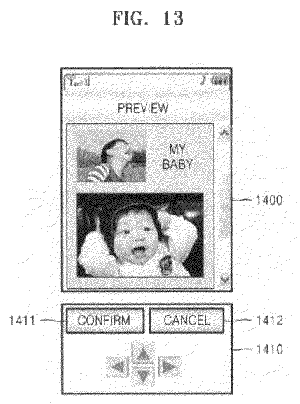

By using the digital content files selected in operation 110, the user edits a layout in operation 120. FIG. 12A illustrates a data structure storing editing information of the layout generated by receiving an input of a user to set a layout when digital content is image content, according to an embodiment of the present invention. FIG. 12B illustrates a data structure storing editing information of a layout generated by receiving an input of a user to set a layout when digital content is text content, according to an embodiment of the present invention. Here, a content number (ID) is an identifier assigned with respect to a content box forming a layout and can be used as a class name in XHTML-Print data.

A preview screen allowing the user to view the layout edited in operation 120 is provided in operation 130. A preview menu 1400, as illustrated in FIG. 13, is an example of the preview screen provided in operation 130. However, it is understood that a separate preview screen need not be used in all aspects.

After the preview screen is provided, it is determined whether there is a request from the user to re-edit the layout in operation 140. If the user presses the confirm button 1411 of the manipulation menu 1410 illustrated in FIG. 13, it is determined that there is no request to re-edit the layout. If the user presses the cancel button 1412, it is determined that there is a request to re-edit the layout from the user.

If it is determined in operation 140 that there is a request to re-edit the layout from the user, an input by the user to again select digital content to be used to make a layout from among the digital content files retrieved in operation 100 is received prior to operation 110. In this way, editing of the layout (operation 120) is performed again. Then, a preview screen is provided (operation 130) and the user is given another opportunity to re-edit the layout (operation 140).

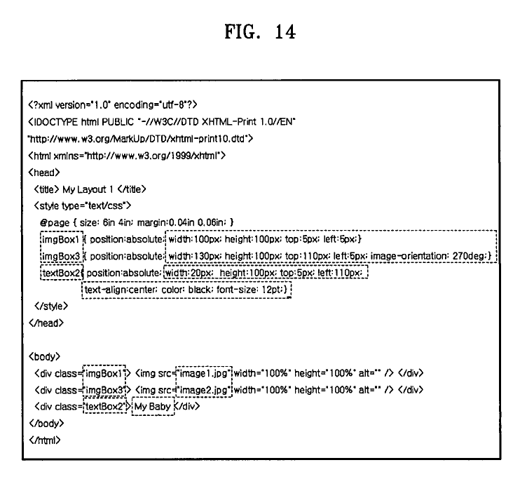

If it is determined in operation 140 that there is no request to re-edit the layout from the user, the layout edited in operation 120 is applied to generate XHTML-Print data in operation 150. In operation 150, the information on the layout edited in operation 120 is first stored. Then, the stored layout information is generated as XHTML-Print data, such as shown in FIG. 14. The areas indicated within dotted lines in FIG. 14 are XHTML code implementing the data structures illustrated in FIGS. 12A and 12B as XHTML-Print data.

The device may then transmit the XHTML-Print data generated in operation 150 to an image forming apparatus by using a wired communication method, such as cable and connection terminals, or a wireless communication method, such as Bluetooth or infrared communication in operation 160. While not required, the XHTML-Print data can also be transferred using a recording medium, such as flash media, in other aspects.

In operation 170, the image forming apparatus executes a printing job by using the XHTML-Print data transmitted in operation 160. However, it is understood that the image forming apparatus does not necessarily print the XHTML-Print data, and may store the XHTML-Print data, to be printed at a later time, and/or retransmit the data to another device for printing across a network.

FIG. 1B is a detailed flowchart of operation 120 of the method of generating XHTML-Print data in a device according to an embodiment of the present invention. An interface allowing the user to edit a layout for the digital content selected in operation 110 of FIG. 1A is provided in operation 111. FIG. 4 illustrates a device providing a user interface to set a layout. FIG. 6 illustrates a user interface of a device according to an embodiment of the present invention. The interface provided in operation 111 includes a layout editing interface 600 and a manipulation menu 650. The layout editing interface 600 includes a content selection menu 610 and an editing menu 620. In the content selection menu 610, the user can select digital content on which editing of a layout is to be performed. By using the manipulation menu 650, a job command related to the editing of the layout is input by the user. It is understood that other configurations of the user interface may be used to edit the layout, such as a touch screen and/or a drag-and-drop functionality to select the digital content.

In operation 112, digital content to be inserted into the layout is selected through the interface provided in operation 111. The user selects one or more digital content files to be inserted into the layout from the list of digital content files displayed on the content selection menu 610 by using a direction button 651 disposed on the manipulation menu 650. If an insert button 652 is selected, the digital content file corresponding to the manipulation of the direction button 510 is selected. It is understood that, according to other aspects of the present invention, the device may include other methods to select digital content files displayed on the device, such as a touch screen, a drag-and-drop functionality, or a plurality of buttons. In this case, in order to distinctively refer to each digital content file in the content selection menu 610, each digital content file is displayed together with an identifier, such as a number label or a predetermined color, as illustrated in FIG. 6. It is understood that other distinctive features may be used to refer to each digital content file, such as a letter label or a name of the file. Also, identifiers may be used to display positions for respective content files forming the layout so that the positions correspond to respective content files included in the selected list of content files. When the user wants to add digital content to the content selection menu 610, the user may press an add list button 654 and the interface provided in operation 110 is provided again.

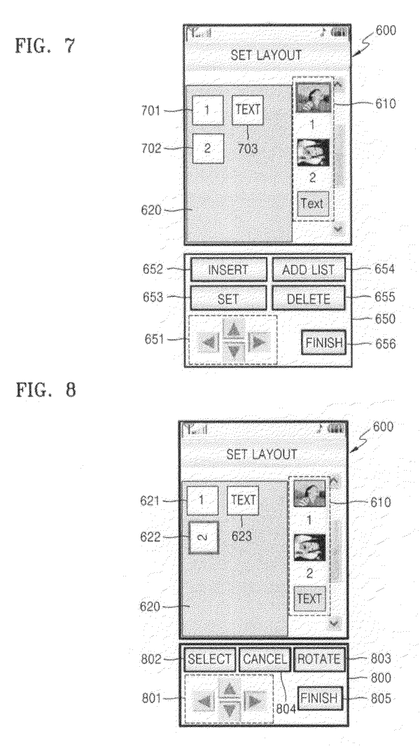

In operation 113, the digital content selected in operation 112 is inserted into the layout. FIG. 7 illustrates a layout editing interface in which a plurality of digital content files is inserted into the layout. In operation 112, a first image 701, a second image 702, and text 703 are selected and, in operation 113, are inserted into the layout, as illustrated in FIG. 7.

In operation 113, the size and position of the digital content inserted into the layout are displayed using lines or areas. By displaying the digital content with lines or areas instead of directly displaying the digital content, limited resources of the device can be efficiently used. However, it is understood that according to another aspect, the digital content can be displayed directly.

If the user selects predetermined digital content from the list of digital content files displayed in the content selection menu 610, a digital content file disposed in the editing menu 620 corresponding to the selected digital content file is distinctively expressed, such as by displaying the outline of a content box having thick solid lines around the selected digital content file.

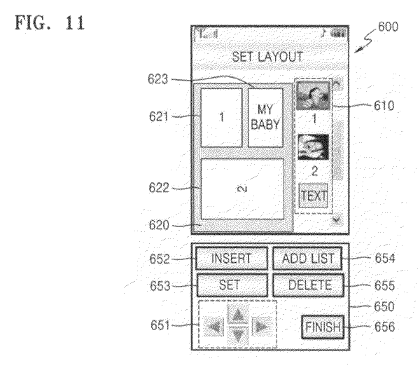

After operation 113, it is determined whether there is a request from the user to set digital content in operation 114 based on whether there is an input of a set button 653 from the user. If there is a request to set the digital content, it is determined in operation 115 whether the digital content for which the request to set is received is text content 623 or image content 621 and 622. If the digital content is text content 623, an input from the user to set the contents of the text 623, the position of the text 623 in the layout, the size of the space occupied by the text 623, and/or the properties of the text 623 is received in operation 116. Furthermore, a text set menu 1000, as illustrated in FIG. 10, is provided. If an input signal of a text input button 1002 is received, an interface for the user to input text into the digital content 623 is provided. If an input of a position button 1003 is received, a function for the user to set the position of the digital content 623 by using a direction button 1001 is provided. If an input of a size button 1004 is received, a function for the user to set the size of the digital content 623 disposed in the layout is provided. If an input of an arrange button 1005 is received, a function for the user to arrange the text 623 is provided. If an input of a color button 1006 is received, a function for the user to set the color of the text 623 is provided. If an input of a font size button 1007 is received, a function for the user to adjust the size of the font of the text 623 is provided. A style button 1008 provides a function for the user to set the style of the text 623. If the setting of the text content 623 is completed, the user inputs a finish button 1009. It is understood that, according to other aspects of the present invention, the device may include other methods to set the text content, such as a touch screen, a drag-and-drop functionality, or a drop-down menu. If an input signal of the finish button 1009 is received, the layout editing interface 600 and the manipulation menu 650, illustrated in FIG. 11, are displayed.

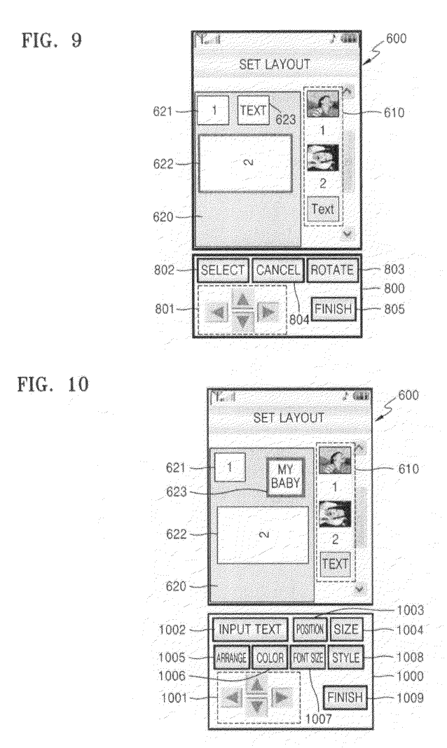

If the digital content is image content 621 and 622, an input from the user to set the position of the image 621 and 622 in the layout, the size of the image 621 and 622, and/or the rotation angle of the image 621 and 622 is received in operation 117. Furthermore, an image set menu 800, as illustrated in FIGS. 8 and 9, is provided. If an input of a rotation button 803 is received, a function for the user to rotate an inserted image 621 and 622 is provided. For example, it may be set that whenever an input of the rotation button 803 is received, the inserted image 621 and 622 rotates by 90 degrees. The user may adjust the size or position of the selected image by using the direction button 801. The user may adjust a specific image content file by inputting the select button 802. Also, the user may cancel an action taken by inputting the cancel button 804. If the setting of the image content is completed, the user inputs a finish button 805. It is understood that, according to other aspects of the present invention, the device may include other methods to set the image content, such as a touch screen, a drag-and-drop functionality, or a drop-down menu. If an input signal of the finish button 1009 is received, the layout editing interface 600 and the manipulation menu 650, illustrated in FIG. 11, are displayed.

After operation 116 or 117, if an input of the finish button 805 or 1009 is received from the user, it is determined whether there is a request from the user to delete digital content in operation 119 based on whether an input signal of a delete button 655 of FIG. 6 is received.

If there is a request from the user to delete digital content, an input from the user to select digital content to be deleted is received in operation 121. In operation 121, the user indicates selection of a predetermined digital content file by moving the content box with the direction button 651.

The digital content selected in operation 121 is deleted from the layout in operation 122.

After operation 122, it is determined whether there is digital content to be additionally inserted in operation 123.

If there is digital content to be additionally inserted, an input signal to select digital content to be inserted into the layout is received in operation 112, through the interface provided in operation 111. If the user then inputs the finish button 656, a preview screen of the edited layout is provided in operation 130 of FIG. 1

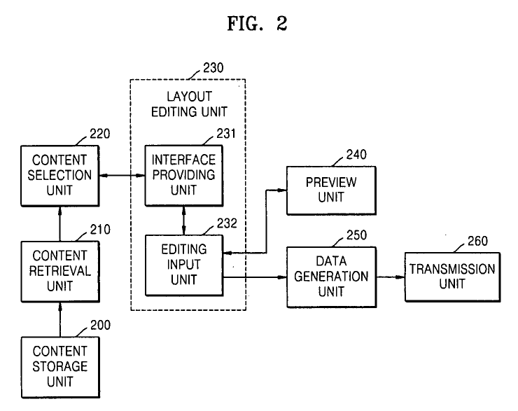

FIG. 2 is a block diagram of an apparatus to generate XHTML-Print data in a device according to an embodiment of the present invention. The apparatus to generate XHTML-Print data in a device includes a content storage unit 200, a content retrieval unit 210, a content selection unit 220, a layout editing unit 230, a preview unit 240, a data generation unit 250, and a transmission unit 260. While not required in all aspects, the device can be a mobile phone, a camera, a mobile device, and/or a computer.

The content storage unit 200 stores digital content, such as image content 621 and 622 or text content 623. The content retrieval unit 210 retrieves digital content stored in the content storage unit 200. The content storage unit 200 can be a memory, such as a hard drive, a flash memory, an SD card, or other removable and/or non-removable media. The content selection unit 220 receives an input from the user to select digital content files to be used to make a layout from among the content files retrieved by the content retrieval unit 210.

The layout editing unit 230 receives an input from the user to edit the layout by using the digital content files selected in the content selection unit 220. Here, the layout editing unit 230 includes an interface providing unit 231 and an editing input unit 232.

The interface providing unit 231 provides an interface for the user to edit the layout by using the digital content files selected in the content selection unit 220. Here, the interface displays the list of digital content files selected in the content selection unit 220 so that the user can edit the layout with the digital content files selected in the content selection unit 220. If the digital content is text content 623, the layout can be edited by setting, for example, the contents of the text 623, the position of the text 623 in the layout, the size of the space required by the text 623, and/or the properties of the text 623. Here, the properties of the text 623 indicate, for example, a color, size, and/or style of a font. If the digital content is image content 621 and 622, the layout can be edited by setting, for example, the position of the image 621 and 622 in the layout, the size of the image 621 and 622, and/or the rotation angle of the image 621 and 622.

The interface providing unit 231 displays the size and position of the digital content forming the layout by using lines or areas, as illustrated in FIG. 7, when the layout is edited. Also, identifiers, such as a number label or color, may be used to display positions for respective content files forming the layout so that the positions correspond to respective content files included in a list of content files. This use of identifiers can be used where the processing capacity of the device is limited. Accordingly, images are not directly displayed and each content file is distinguished by the identifier. Then, if the user selects a predetermined digital content file in the list of content files, the content file disposed in the layout corresponding to the selected content file is distinctively displayed. Here, an embodiment of distinctively displaying the digital content is displaying the outline of the content box by using thick solid lines.

The user may insert a plurality of identical digital contents in the layout. Also, each digital content file forming the layout can be edited or set by the user. The editing input unit 232 receives an input including editing information for the layout from the user through an interface provided by the interface providing unit 231.

The preview unit 240 provides a preview screen, such as the preview menu 1400 illustrated in FIG. 13, in which the user can view in advance a layout in a predetermined form generated using the editing information of the layout input through the editing input unit 232. The user confirms the layout through the preview screen provided by the preview unit 240, and can re-edit the layout by pressing a cancel button 1412.

The data generation unit 250 generates XHTML-Print data by applying the layout generated using the editing information input by the editing input unit 232. The data generation unit 250 stores the layout information edited in the editing input unit 232 and generates the stored layout information as XHTML-Print data. The dotted lines in FIG. 14 indicate the layout editing unit that outputs the data structures illustrated in FIGS. 12A and 12B to be applied as XHTML-Print data.

The transmission unit 260 transmits the XHTML-Print data generated in the data generation unit 250 to an image forming apparatus by using a wired communication method, such as cable and connection terminals, and/or a wireless communication method, such as Bluetooth or infrared communication. By using the transmitted XHTML-Print data, the image forming apparatus may perform printing or other functions on the XHTML-Print data.

Aspects of the present invention can also be embodied as computer-readable codes on a computer-readable recording medium. The computer-readable recording medium may be any data storage device that can store data which can be thereafter read by a computer system or a computer-readable code processing apparatus. Examples of the computer-readable recording medium include read-only memory (ROM), random-access memory (RAM), CD-ROMs, magnetic tapes, floppy disks, and optical data storage devices.

According to the method and apparatus to generate XHTML-Print data in a device, the user can edit a layout of digital content in a device and generate XHTML-Print data.

By doing so, since the user edits the layout in the device, the user can achieve a wider variety of desired printing results. Also, in an environment where the resources of the device are limited, the user can easily and conveniently edit the layout.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of generating extensible hypertext markup language (XHTML)-Print data in a device in which XHTML data is generated, the method comprising:
selecting one or more digital content files;
editing a layout in relation to the selected one or more digital content files; and
generating XHTML-Print data of the edited layout.

2. The method as claimed in claim 1, wherein the editing of the layout comprises inserting one or more of the selected one or more digital content files into the layout.

3. The method as claimed in claim 1, wherein the editing of the layout comprises:
providing an interface to edit the layout in relation to the selected one or more digital content files; and
receiving an input to edit the layout in relation to the selected one or more digital content files through the provided interface.

4. The method as claimed in claim 3, wherein in the interface, the layout and a list of the selected digital content files are separately displayed.

5. The method as claimed in claim 1, wherein the selected one or more digital content files forming the layout comprises image content, and the editing of the layout comprises setting a position of the image content in the layout, a size of the image content, and/or a rotation angle of the image content.

6. The method as claimed in claim 1, wherein the selected one or more digital content files comprises text content, and the editing of the layout comprises setting a contents of the text content, a position of the text content in the layout, a size of the space of the text content, and/or properties of the text content.

7. The method as claimed in claim 2, wherein the inserting of the one or more digital content files comprises selecting the one or more digital content files from a list of the selected one or more digital content files.

8. The method as claimed in claim 7, wherein the selecting of the one or more digital content files comprises dragging and dropping the one or more digital content files from the list of the selected one or more digital content files onto the layout.

9. The method as claimed in claim 1, wherein the editing of the layout comprises depicting a size and a position of digital content of the selected one or more digital content files forming the layout with lines and/or areas.

10. The method as claimed in claim 1, wherein the editing of the layout comprises displaying identifiers corresponding to the content files of the selected one or more digital content files forming the layout.

11. The method as claimed in claim 7, wherein the editing of the layout comprises distinctively displaying a predetermined digital content file in the layout when the user selects the predetermined digital content file from the list of the selected one or more digital content files.

12. The method as claimed in claim 2, wherein the inserting of the one or more digital content files comprises inserting a first digital content file one or more times into the layout.

13. The method as claimed in claim 1, wherein the editing of the one or more digital content files comprises editing and/or deleting from the layout a first digital content file of the selected one or more digital content files forming the layout.

14. The method as claimed in claim 1, further comprising displaying a preview of the edited layout.

15. The method as claimed in claim 1, wherein the generating of the XHTML-Print data comprises storing the edited layout information and generating the stored layout information as the XHTML-Print data.

16. The method as claimed in claim 1, further comprising printing the generated XHTML-Print data.

17. The method as claimed in claim 1, further comprising transmitting the generated XHTML-Print data to an image forming apparatus.

18. The method as claimed in claim 1, wherein the selecting of the one or more digital content files comprises:
retrieving a plurality of digital content files; and
selecting the one or more digital content files from the plurality of digital content files.

19. The method as claimed in claim 18, wherein the selecting of the one or more digital content files further comprises retrieving the plurality of digital content files from a storage unit in the device and/or through a wired or wireless communication method.

20. The method as claimed in claim 1, wherein the device is a mobile device.

21. The method as claimed in claim 1, wherein the device comprises a camera which captures a picture and creates the digital content file therefrom.

22. A computer-readable medium encoded with processing instructions to perform the method of claim 1 implemented by a computer.

23. An apparatus to generate XHTML-Print data in a device in which XHTML data is generated, the apparatus comprising:
a data selection unit to select one or more digital content files;
a layout editing unit to edit a layout in relation to the selected one or more digital content files; and
a data generation unit to generate XHTML-Print data of the edited layout.

24. The apparatus as claimed in claim 23, further comprising a content retrieval unit to retrieve a plurality of digital content files.

25. The apparatus as claimed in claim 24, further comprising a content storage unit to store the plurality of digital content files, wherein the content retrieval unit retrieves the plurality of digital content files from the content storage unit.

26. The apparatus as claimed in claim 24, wherein the content retrieval unit retrieves the plurality of digital content files from an external storage unit through a wired or wireless communication method.

27. The apparatus as claimed in claim 24, wherein the data selection unit receives an input from a user to select the one or more digital content files from the plurality of digital content files retrieved by the content retrieval unit.

28. The apparatus as claimed in claim 23, wherein the layout editing unit receives an input to insert one or more digital content files, from the selected one or more digital content files, into the layout.

29. The apparatus as claimed in claim 23, wherein the layout editing unit comprises:
an interface providing unit to provide an interface to edit the layout in relation to the selected one or more digital content files; and
an editing input unit to receive an input to edit the layout in relation to the selected one or more digital content files through the provided interface.

30. The apparatus as claimed in claim 29, wherein the interface providing unit displays a list of the selected one or more digital content files and displays identifiers on a layout corresponding to one or more of the selected one or more digital content files forming the layout.

31. The apparatus as claimed in claim 29, wherein the interface providing unit displays a size and a position of each of the selected one or more digital content files forming the layout with lines and/or areas.

32. The apparatus as claimed in claim 29, wherein the selected one or more digital content files comprises image content, and the editing input unit receives inputs selectable between a position of the image content in the layout, a size of the image content, and a rotation angle of the image content.

33. The apparatus as claimed in claim 29, wherein the selected one or more digital content files comprises text content, and the editing input unit receives inputs selectable between a contents of the text content, a position of the text content in the layout, a size of the space of the text content, and properties of the text content.

34. The apparatus as claimed in claim 23, wherein the layout editing unit receives an input to insert a first digital content file, from the selected one or more digital content files, into the layout more than once.

35. The apparatus as claimed in claim 23, further comprising a preview unit to display a preview of the edited layout.

36. The apparatus as claimed in claim 23, further comprising a transmission unit to transmit the XHTML-Print data generated by the data generation unit to an image forming apparatus.

37. The apparatus as claimed in claim 23, wherein the device is a mobile device.

38. The apparatus as claimed in claim 23, wherein the device comprises a camera which captures a picture and creates the digital content file therefrom.

39. A method of generating extensible hypertext markup language (XHTML)-Print data in a device in which XHTML data is generated, the method comprising:
editing a layout of one or more digital content files; and
generating XHTML-Print data of the edited layout.

40. The method as claimed in claim 39, further comprising selecting the one or more digital content files from a plurality of digital content files.

41. The method as claimed in claim 40, wherein the editing of the layout comprises inserting one or more of the selected one or more digital content files into the layout.

42. The method as claimed in claim 39, wherein the one or more digital content files comprises image content, and the editing of the layout comprises setting a position of the image content in the layout, a size of the image content, and/or a rotation angle of the image content.

43. The method as claimed in claim 39, wherein the one or more digital content files comprises text content, and the editing of the layout comprises setting a contents of the text content, a position of the text content in the layout, a size of the space of the text content, and/or properties of the text content.

44. The method as claimed in claim 39, wherein the editing of the layout comprises depicting a size and a position of each of the one or more digital content files forming the layout with lines and/or areas.

45. The method as claimed in claim 39, wherein the editing of the layout comprises displaying identifiers corresponding to each of the one or more digital content files forming the layout.

46. The method as claimed in claim 39, wherein the editing of the one or more digital content files comprises editing and/or deleting from the layout a first digital content file of the one or more digital content files forming the layout.

47. The method as claimed in claim 39, wherein the generating of the XHTML-Print data comprises storing the edited layout information and generating the stored layout information as the XHTML-Print data.

48. The method as claimed in claim 39, further comprising transmitting the generated XHTML-Print data to an image forming apparatus.

49. A computer-readable medium encoded with processing instructions to perform the method of claim 39 implemented by a computer.

50. An apparatus to generate XHTML-Print data in a device in which XHTML data is generated, the apparatus comprising:
a layout editing unit to edit a layout for use with one or more digital content files to be printed; and
a data generation unit to generate XHTML-Print data of the edited layout.

51. The apparatus as claimed in claim 50, further comprising a content retrieval unit to retrieve a plurality of digital content files.

52. The apparatus as claimed in claim 51, further comprising a data selection unit to receive an input selecting the one or more digital content files from the plurality of digital content files retrieved by the content retrieval unit.

53. The apparatus as claimed in claim 50, wherein the layout editing unit receives an input to insert the one or more digital content files, from a plurality of digital content files, into the layout.

54. The apparatus as claimed in claim 50, wherein the layout editing unit comprises:
an interface providing unit to provide an interface to edit the layout of the one or more digital content files; and
an editing input unit to receive an input to edit the layout of the one or more digital content files through the provided interface.

55. The apparatus as claimed in claim 54, wherein the interface providing unit displays a list of the one or more digital content files and displays identifiers on a layout corresponding to each of the one or more digital content files forming the layout.

56. The apparatus as claimed in claim 54, wherein the interface providing unit displays a size and a position of each of the one or more digital content files forming the layout with lines and/or areas.

57. The apparatus as claimed in claim 54, wherein the one or more digital content files comprises image content, and the editing input unit receives inputs to set a position of the image content in the layout, a size of the image content, and/or a rotation angle of the image content.

58. The apparatus as claimed in claim 54, wherein the one or more digital content files comprises text content, and the editing input unit receives inputs to set a contents of the text content, a position of the text content in the layout, a size of the space of the text content, and/or properties of the text content.

59. The apparatus as claimed in claim 50, further comprising a transmission unit to transmit the XHTML-Print data generated by the data generation unit to an image forming apparatus.
